(19) United States
(12) Patent Application Publication
(10) Pub. No.: US 2016/0189148 A1
(43) Pub. Date: Jun. 30, 2016

(54) PCI-COMPLIANT METHOD FOR EXCHANGING CREDIT CARD INFORMATION IN ONLINE MARKETPLACES

(71) Applicant: Operator, Inc., San Francisco, CA (US)

(72) Inventors: Philip Fung, San Francisco, CA (US); Sameer Moidu, San Francisco, CA (US); Robin Chan, San Francisco, CA (US); Jonathan Lieberman, San Francisco, CA (US)

(21) Appl. No.: 14/973,654

(22) Filed: Dec. 17, 2015

Related U.S. Application Data
(60) Provisional application No. 62/098,283, filed on Dec. 30, 2014.

(51) Int. Cl. G06Q 20/38; G06Q 20/24; G06Q 20/34

(52) U.S. Cl. CPC G06Q 20/3829; G06Q 20/34; G06Q 20/24; G06Q 2220/00

(57) ABSTRACT

A system and a method are disclosed for conducting a transaction of purchasing goods at online marketplaces including a secure electronic method of credit card information exchange that represents a physical handover of the credit card and return of the credit card. A consumer sends a request to view goods. The system responds with a list of available goods from one or more merchants. The consumer selects an available good and sends a request to purchase it by sending credit card information. The credit card information is encrypted with a public key retrieved from a server, and transmitted to the merchant device. The merchant device decrypts the information using a private key unique to the merchant device. Then credit card information is available at the merchant device for a specific period of time and is destroyed once the time expires or the purchase is marked as complete.

### CROSS REFERENCE TO RELATED APPLICATIONS

This application claims the benefit of U.S. Provisional Application No. 62/098,283, filed Dec. 30, 2014, which is incorporated by reference in its entirety.

### BACKGROUND

1. Field of Art

The disclosure generally relates to the field of secure electronic transactions, and more specifically, providing a secure, encrypted electronic method of credit card information exchange that represents a physical handover of the credit card and return of the credit card at a marketplace.

2. Description of the Related Art

Purchasing products and services (goods) via the internet using smart mobile devices has become common today. Many merchants set up online marketplaces that can be easily accessed via the mobile devices. As a part of setting up an online marketplace, a merchant needs to set up a method for receiving a payment from a consumer for conducting the sale of goods electronically. The merchant generally uses a third party payment application provider service to set up the method of receiving payments and provides their bank account details to the third party service provider in order to receive payments electronically. A consumer uses the third party payment service to pay for the goods bought online from the merchant and provides credit card information through the third party application in order to complete the purchase of goods from a merchant in the online marketplace. The merchant's bank account details and the consumer's credit card information reside on the server associated with the third party application provider.

This method of setting up a payment method and receiving credit card information is (a) not secure and (b) requires significant integration effort to set up a new merchant on the marketplace. Regarding (a), the server of the third party application may be susceptible to hacking, leading to potential misuse of confidential information residing on the server. Moreover, there is a trust issue because the third party service provider has access to the confidential information of the consumer and the merchant. Regarding (b), the process of setting up a new merchant requires significant effort because the merchant needs to provide and link their bank account to the third party application. This is a tedious step that can require a lot of business persuasion for a new marketplace, especially if the new merchants are large corporations. It is much easier to sign up new merchants if they are allowed to use their existing payments systems instead, as described in this specification.

### BRIEF DESCRIPTION OF DRAWINGS

The disclosed embodiments have advantages and features which will be more readily apparent from the detailed description, the appended claims, and the accompanying figures (or drawings). A brief introduction of the figures is below.

FIG. 1 illustrates an example embodiment of a credit card exchange system for an online marketplace.

FIG. 2 illustrates an example embodiment of steps performed by a consumer application in conducting a transaction with online merchants.

FIG. 3 illustrates an example embodiment of steps performed by a merchant application in conducting a transacting with a consumer application.

FIG. 4 illustrates an example embodiment of an event trace for conducting transactions and exchanging credit card information in an online marketplace.

FIGS. 5-12 illustrate an example embodiment of user interfaces associated with conducting a transaction and securely exchanging credit card information through an online marketplace.

FIG. 13 illustrates one embodiment of components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method, and a computer program product (comprised of a computer readable storage medium storing computer instructions thereon) that includes a credit card exchange system that can be used to conduct a transaction of purchase of goods from online merchants. The system provides a mechanism for digitally representing a physical handover of a credit card between a merchant and consumer in a physical marketplace such that the merchant does not retain the credit card itself. The system further provides a process to conduct the transaction of purchase of goods between an online merchant and a consumer.

The process includes receiving a request from a consumer device to view goods from online merchants, each online merchant is associated with a merchant device. In response to the request from the consumer device, a list of available goods from the online merchants is transmitter to the consumer device. In some embodiments, the list is generated by performing a keyword search amongst the goods available for purchase from the online merchants.

The process further includes receiving a request from the consumer device to purchase goods from one of the online merchants. In response, the process further includes receiving a request to obtain credit card information and shipping information from the merchant device associated with the online merchant from which the purchased goods were requested by the consumer device. The process further includes receiving the credit card information and shipping information from the consumer device and encrypting the credit card information using a public key. The public key may be retrieved from a server. The encrypted credit card information and the shipping information is transmitted to the merchant device over a network.

The credit card information can be decrypted using a private key that can be retrieved from a storage module on the merchant device. The system displays the credit card information for a predefined interval of time and then destroys the information from the merchant device. For the predefined interval of time, when the credit card information is displayed, a screen shot capture detector is enabled.

### Example System Configuration

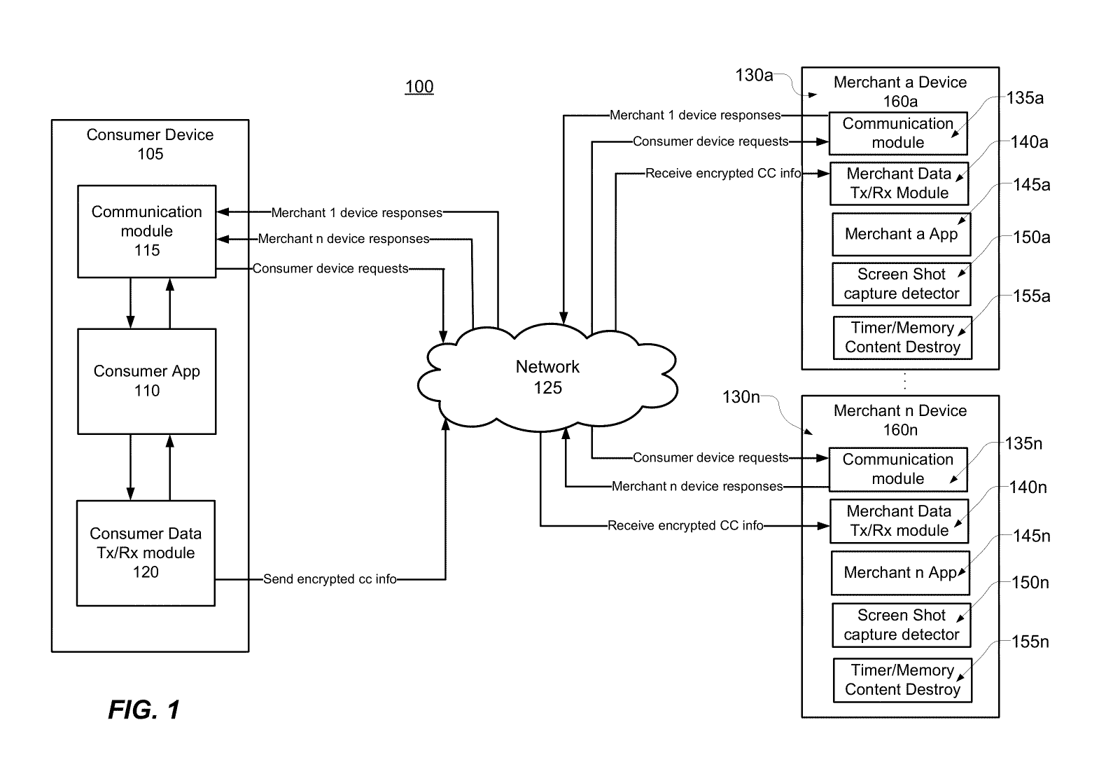

Referring now to FIG. (FIG. 1, illustrated is an example credit card exchange system 100 for one or more online merchants 130a-n (n being the nth online merchant) (generally 130). The system includes a consumer application 110 and merchant applications 145a-n (n being the nth merchant application) (generally 145). The consumer application 110 executes on a consumer device 105. The merchant application 145 executes on a merchant device 160a-n, respectively (n being the nth merchant device) (generally 160). The consumer application 110 and merchant applications 145 communicate via the network 125 through their respective devices 105 and 160.

The consumer application 110 interfaces with a communication module 115 and a consumer data transmission (Tx) and reception (or receiver, Rx) module 120. The communication module 110 comprises of a messaging system that allows the consumer application 110 to send/receive messages to/from the merchant application 145, associated with the online merchants 130. The message can be either a broadcast, e.g., sent to all of the merchant applications 145 or a unicast, e.g., sent to one or more individual merchant applications like 145a or 145n. The messages may include sending requests to view or purchase goods from the online merchants, receiving a list of goods available to purchase from the online merchants, receiving information regarding promotions or sales at various online merchants, or receiving requests for shipping information or credit card information to complete a transaction of purchasing goods. Online merchants will transmit confirmation of said order once it is complete.

The consumer application 110 further interfaces with a consumer data transmission/reception (Tx/Rx) module 120 that sends or receives consumer data to the merchant application 145. The consumer data may include credit card information, billing or shipping address, consumer name, consumer phone number, email address or other such details. The confidential consumer data, for example, the credit card information is encrypted by the consumer application 110 prior to sending it over the network 125 via the consumer data Tx/Rx module 120. The consumer data is encrypted using a public key associated with the merchant application 145.

Each online merchant 130 is associated with a merchant application 145. The merchant application, for example 145a, interfaces with a communication module 135a, a merchant data transmission/reception (Tx/Rx) module 140a, a screen shot capture detector 150a, and a timer and memory content destroyer module 155a. In some embodiments, the merchant device 160 includes a storage module, not shown in the figure. The storage module may include a machine-readable medium disk, memory or other such storage modules. A private key used for purposes of security/encryption/decryption may be stored in the storage module.

The communication module 135a includes a messaging system for sending/receiving messages to/from the consumer device 105. The messages may include receiving requests for viewing or purchasing goods, sending requests to obtain credit card information or shipping information to complete a transaction of purchasing goods. The merchant data Tx/Rx module 140a receives the encrypted credit card information from the consumer device 105 via the network 125. The merchant data Tx/Rx module 140a receives the credit card information and sends it to the merchant application 145a. The merchant application 145a decrypts and displays the credit card information using a private key that resides on the merchant device 160a.

The timer module 155a and the screen shot capture detector 150a are enabled along with the display of the credit card information. The screen shot capture detector 150a detects a screen shot capture on the merchant device 160a within the predefined interval of time, for example, 15 minutes, when the credit card information is being displayed on the merchant device 160a. When the timer reaches the predefined interval of time, or when the merchant application 145a receives a transaction completion notification, the merchant application 145a stops the display of the credit card information. The memory content destroyer 150a deletes the contents of the memory that temporarily stores the credit card information.

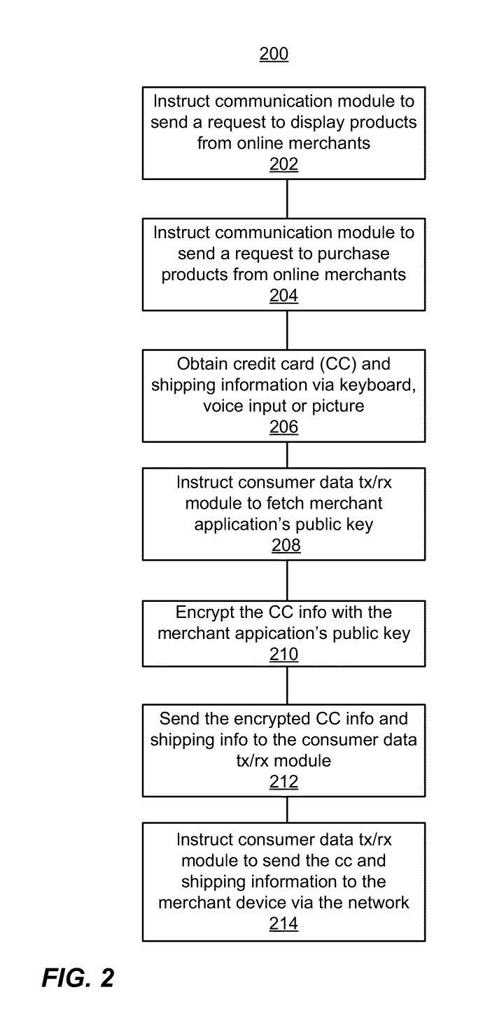

Referring now to FIG. 2, illustrated is an example embodiment of steps performed 200 by a consumer application 110 in conducting a transaction with online merchants 130. The consumer application 110 instructs 202 the communication module 115 residing on the consumer device 105 to send a request to the merchant application 145 to display products from online merchants 130. The request can be a keyword search for example, shoes, scarf, clothing, electronics, etc. The consumer application 110 receives a related product list and displays it on the consumer device 105.

Once a consumer selects a product for purchase, the consumer application 110 instructs the communication module 115 to send a request 204 to the merchant application 145 to purchase the product. The merchant application 145 sends a request to the consumer via the consumer application 110 to obtain credit card and shipping information to complete the transaction of purchasing the product. The consumer application 110 obtains the credit card and shipping information 206 via the keyboard, camera or voice input from the consumer device 105. The credit card information is encrypted before sending it over the network 125 to the merchant application 145. The consumer application 110 instructs 208 the consumer data Tx/Rx module 120 to fetch the merchant application's 145 public key. Once the consumer application 110 receives the public key, it encrypts 210 the credit card information using the public key. The encrypted credit card information and the shipping information are sent 212 to the consumer data Tx/Rx module 120. The shipping information is not encrypted. The consumer application 110 instructs the consumer data Tx/Rx module 120 to send the credit card and shipping information to the merchant device 160 via the network 125.

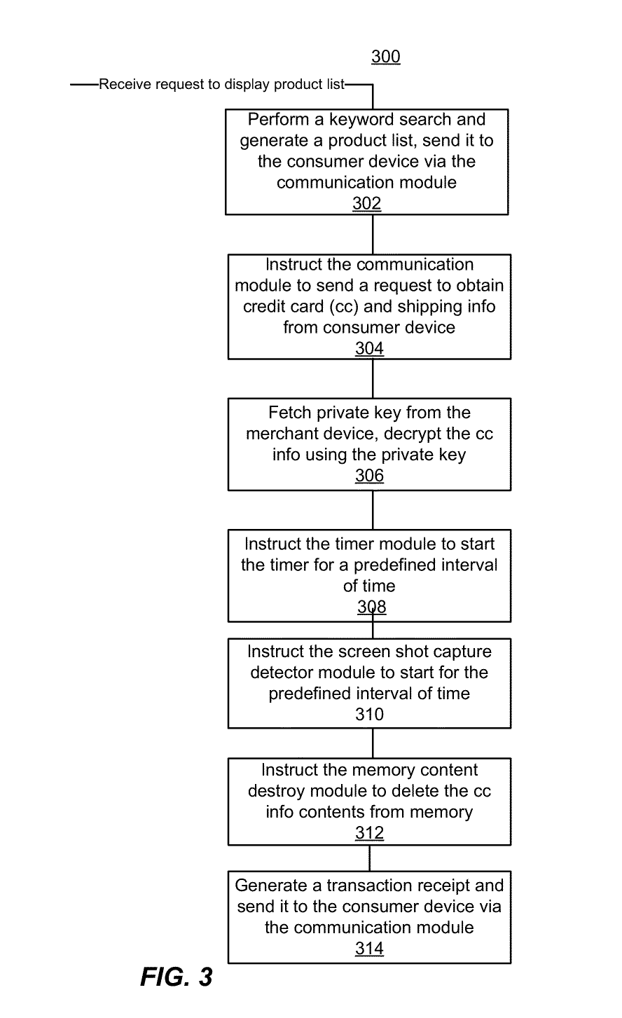

Referring now to FIG. 3, illustrated is an example embodiment of steps performed 300 by a merchant application 145 in conducting a transacting with a consumer application 110. The merchant application 145 receives a request from the consumer application 110 to display a list of products related to the keyword, e.g., shoes, scarf, clothes, etc., sent by the consumer application 110. The merchant application 145 performs a keyword search and generates a list of products available for purchase from one or more online merchants 130 related to the keyword. The merchant application 145 sends 302 the list to the consumer device 105 via the communication module 135. The consumer application 110 may select a product from the list and send a request to the merchant application 145 to purchase the product. The merchant application 145 instructs 304 the communication module 135 to send a request to obtain credit card and shipping information from the consumer device 105 to charge for the product purchase.

The consumer device 105 sends encrypted credit card information to the merchant device 160. The merchant application 145 has to decrypt the credit card information in order to display it on the merchant device 160. The merchant application 145 retrieves a private key from a storage module of the merchant device 160 and decrypts 306 the credit card information. The private key for a merchant device is unique. In some embodiments, the private key may be generated using a random number generator or a pseudo random number generator. In some embodiments, a cryptographic system such as Data Encryption Standard (DES) may be used to generate the private keys for a merchant device 160.

The merchant application 145 concurrently displays the credit card information, instructs the timer module 155 to the start the timer 308 for a predefined interval of time, for e.g., 15 minutes and instructs the screen shot capture detector module 150 to start 310 for the same predefined interval of time.

The merchant can enter the credit card information into the terminal to charge for the purchase of the product, similar to the physical world. Once the credit card is charged, the merchant indicates via a key (e.g., software, electrical, or mechanical) on the merchant device 160 that the transaction has completed. On receiving the transaction completion indication, the merchant application 145 stops the display of credit card and instructs the memory content destroyer module 155 to destroy the contents of the memory location 312 that stored the credit card information. The merchant application 145 completes the transaction by generating a receipt for the purchased product and sending 314 it to the consumer application 110 via the communication module 135.

### Example Process and Example User Interface

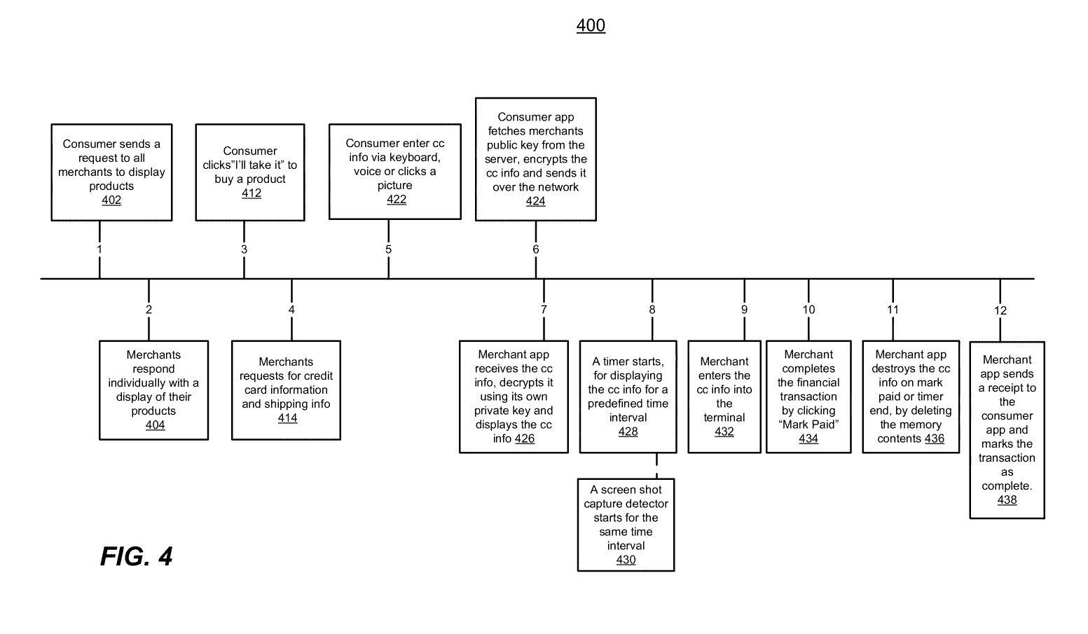

Referring now to FIGS. 4 through 12, illustrated is an event trace and associated exemplary user interfaces displaying an example method of conducting transactions and exchanging credit card information in online merchants. FIG. 4 illustrates an event trace 400 for conducting a transaction and exchanging credit card information for purchasing goods from online merchants. A request to view products 402 is sent to a merchant device 160 associated with an online merchant. For example, a consumer may send a request via the consumer application 110 executing on the consumer device 105 to view shoes, specifically sneakers.

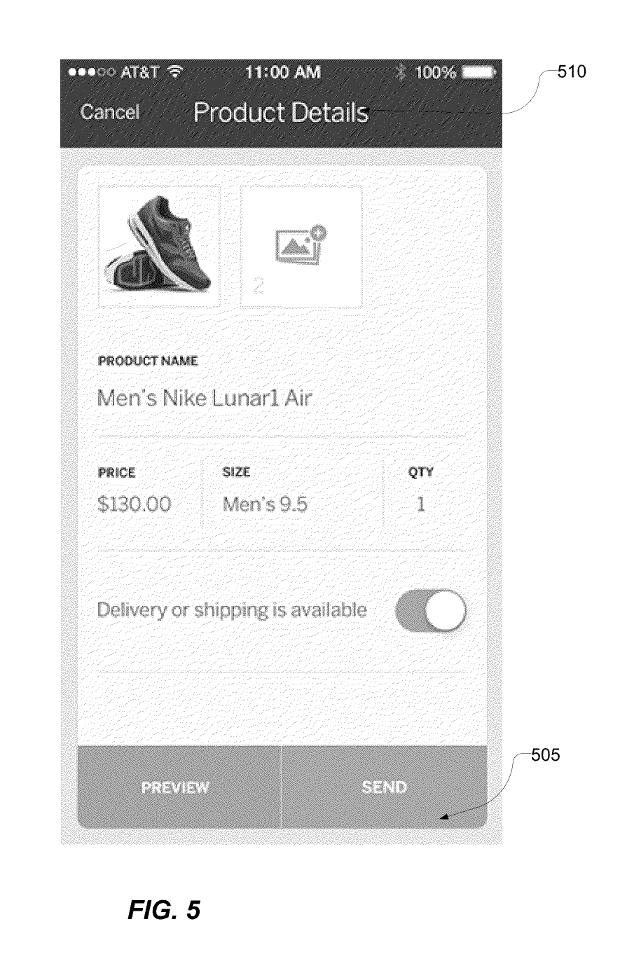

Each online merchant may individually respond 404 via the merchant application 145 executing on the merchant device 160 with a product list relevant to the request made by the consumer. FIG. 5 illustrates an exemplary user interface of an available product at the online merchant. The merchant can select the product details 510 to be sent via the send button 505 on the user interface of the merchant application 145.

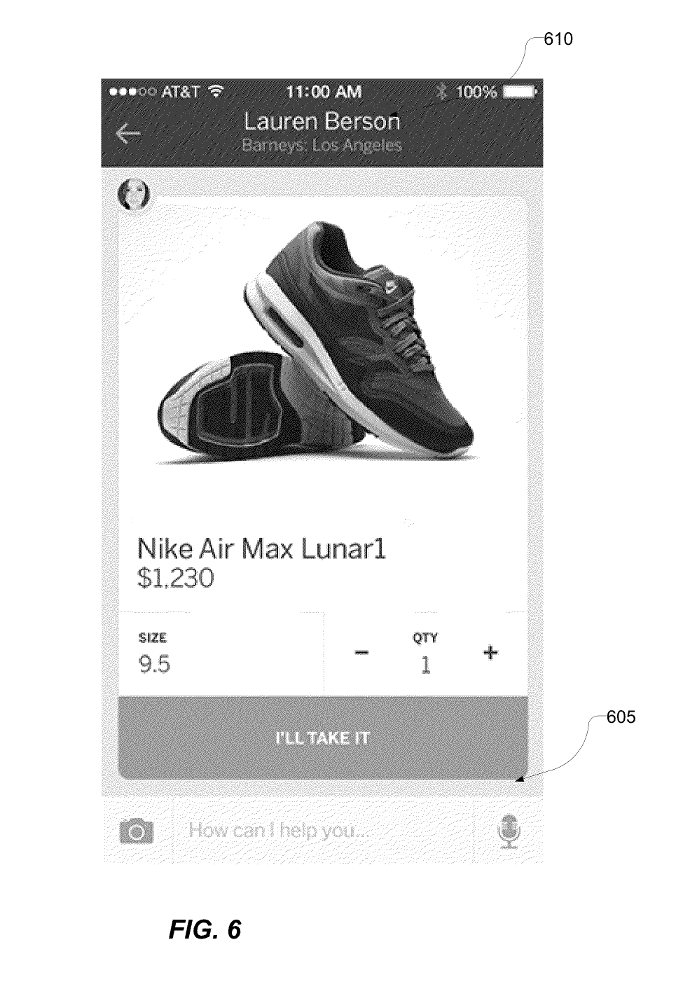

The consumer may view one or more products from one or more online merchants and select a product to purchase 412 via the consumer application 110. FIG. 6 illustrates an exemplary user interface for selecting a product to purchase. The consumer can click on the “I'll take it” button 605 to purchase the product from the online merchant 610.

The merchant device 160 receives the request to purchase the product. The merchant device 160 responds with a request 414 to obtain credit card and shipping information from the consumer to complete the transaction. The consumer application 110 requests the consumer to enter the credit card information and shipping information. The consumer can enter the information 422 via a key (e.g., software, electrical, or mechanical), voice or by taking a picture of the credit card via the consumer device 105.

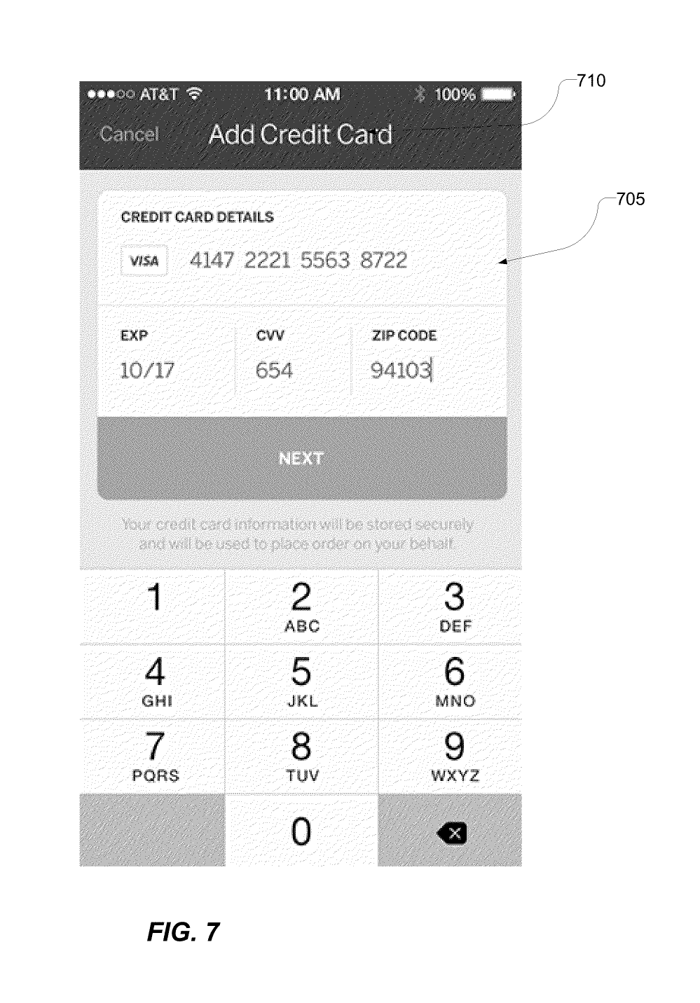

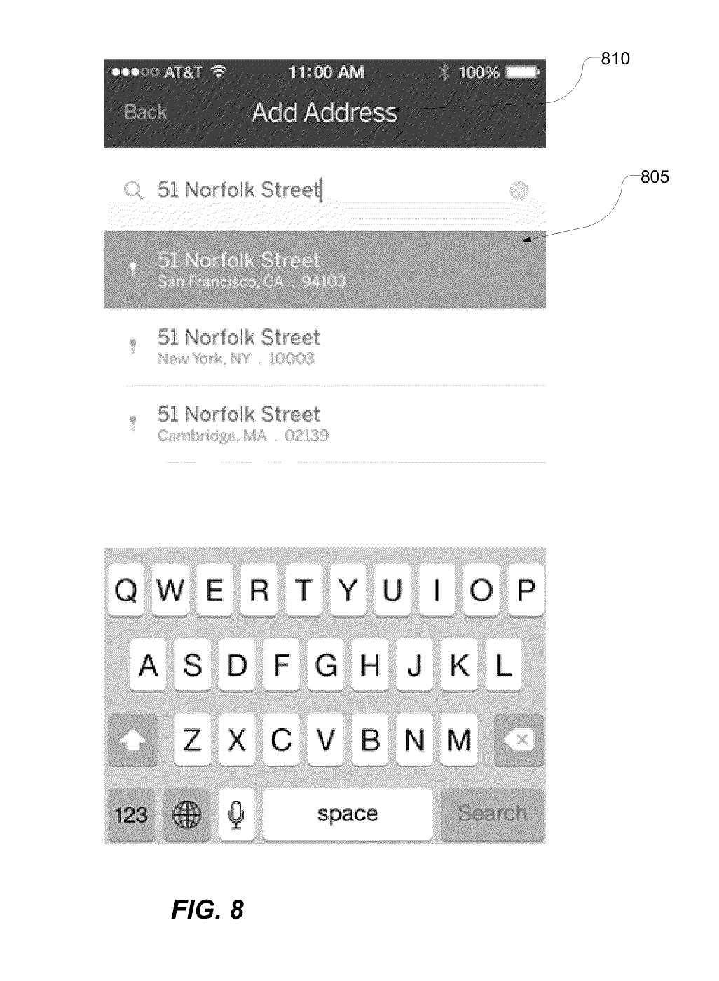

FIGS. 7-8 illustrate exemplary user interfaces for entering credit card information 710 and shipping address 810. In the example user interfaces of FIGS. 7 and 8, the information is entered via the keyboard 705, 805.

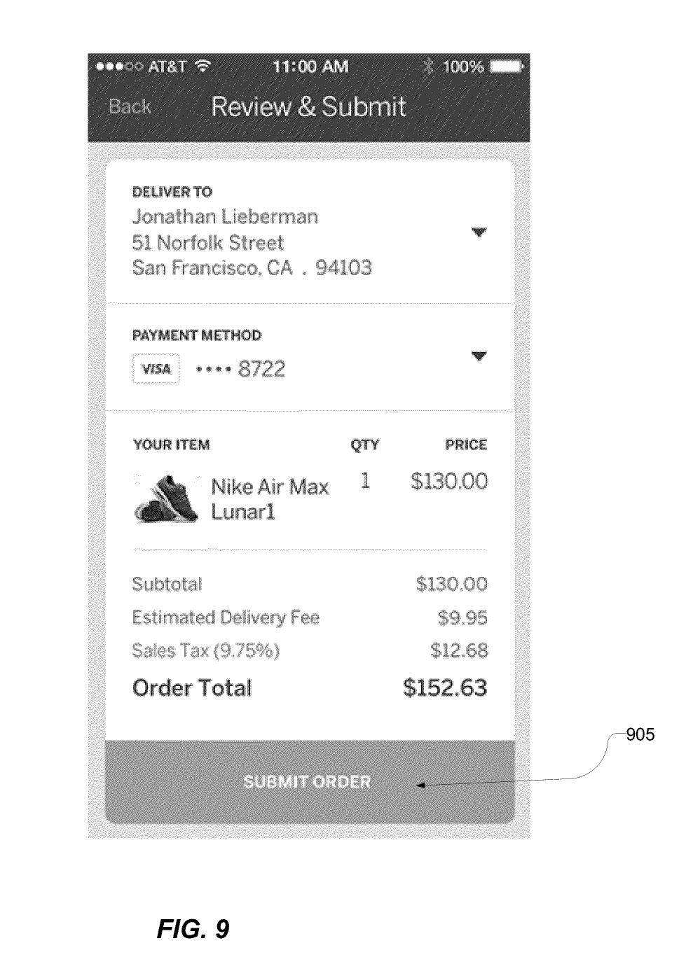

The consumer device 105 obtains a merchant application 145 public key and encrypts the credit card information with it. Alternatively, the consumer device 105 may add an additional layer of security by converting the encrypted credit card information to a machine readable QR barcode. The consumer device 105 sends the encrypted credit card information and the shipping information 424 to the merchant device 160 over the network. FIG. 9 illustrates an exemplary user interface that displays details of a purchase order including the shipping address 915 and the encrypted credit card information 910. The information is sent over the network when the consumer clicks on the “Submit Order” button 905.

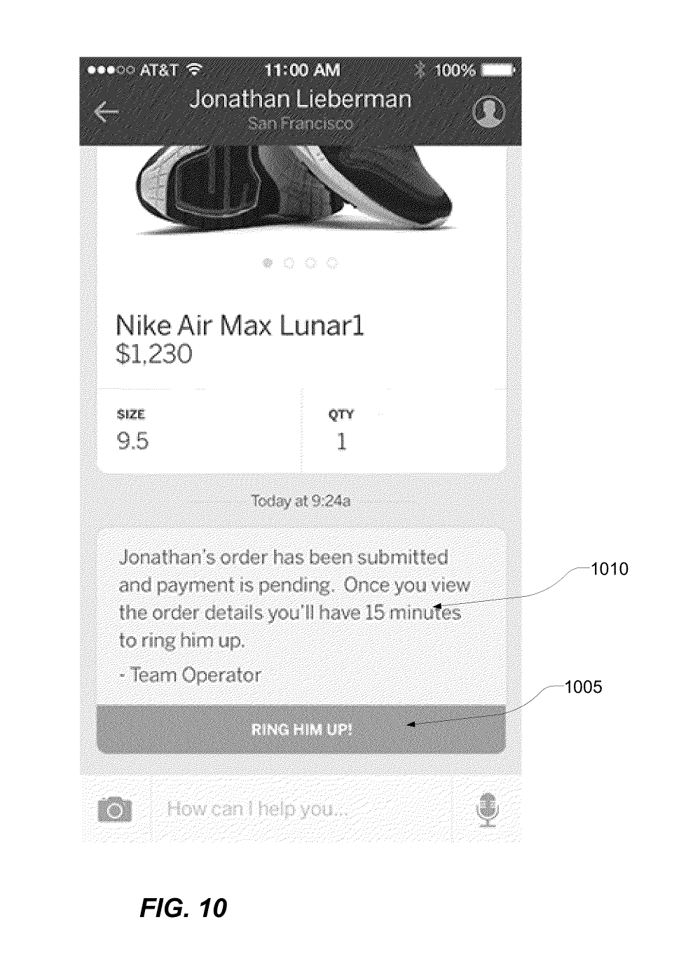

The merchant device 160 receives the encrypted credit card information and the shipping information. A unique private key resides on every merchant device 160. The merchant application 145 obtains the private key from the merchant device and decrypts the credit card information with it. The merchant application 145 displays 426 the credit card information. FIG. 10 illustrates an exemplary user interface for displaying credit card information on the merchant device 160. The credit card information is displayed for a predefined interval of time 1010, for example 15 minutes, when the merchant taps the “Ring him up” button 1005.

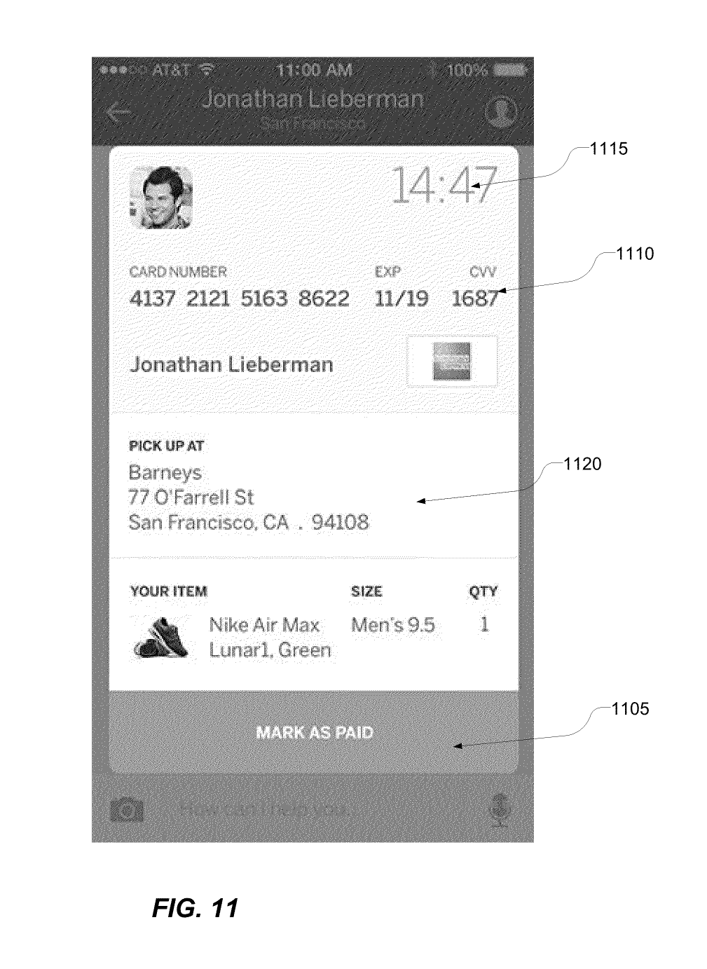

Once the credit card information is displayed by the merchant application 145, a timer starts 428 on the merchant device 160. A screen shot capture detector 150 is enabled 430 for the same predetermined interval of time. FIG. 11 illustrates an exemplary user interface indicating display of the credit card information 1110 and shipping information 1120 on the merchant device 160. The timer starts running for the predefined interval of time 1115.

The merchant can now view and enter the credit card details on a terminal, similar to swiping the credit card details in a physical world, to complete the purchase of goods 432. The merchant application 145 can display the credit card information multiple times in the predefined interval of time, but the credit card can be charged only once, for an amount equivalent to the price of the product being purchased. Once the credit card information is processed by the merchant, the merchant may complete 434 the financial part of the transaction by tapping the “Mark As Paid” button 1105. Credit card information will be displayed for a predefined interval of time 1115 or until the merchant taps the “Mark As Paid” button 1105.

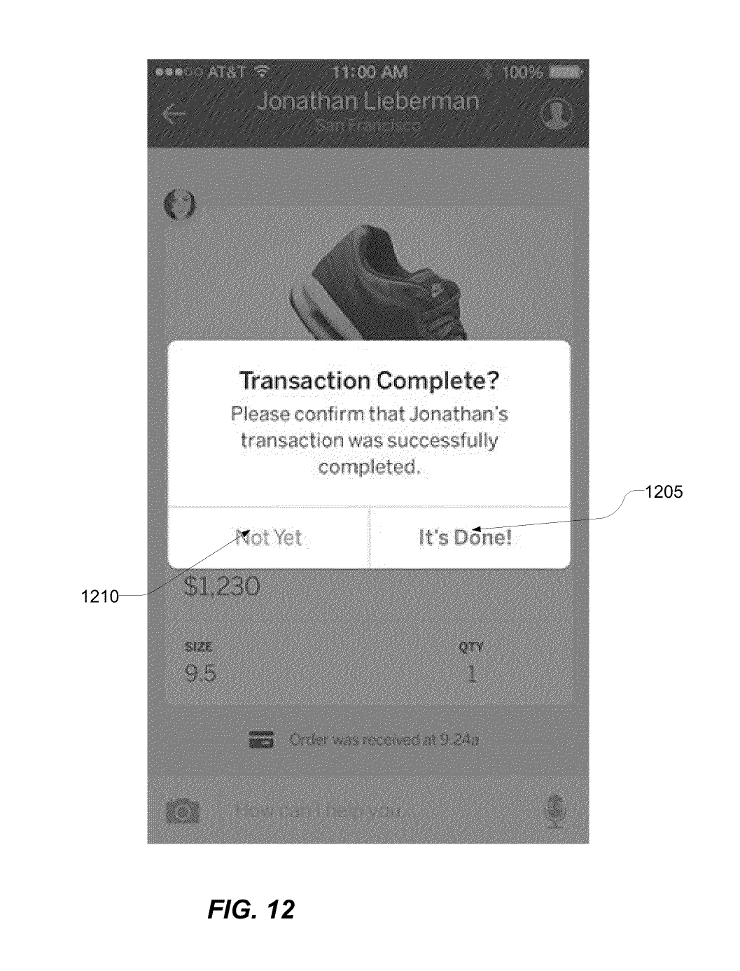

Once the financial part of the transaction is completed or the timer expires, the merchant application 145 destroys 436 the contents of the memory that contained the credit card information on the merchant device 160. The merchant may now complete the transaction by sending a receipt 438 to the consumer device 105 to acknowledge the purchase of the product from the online merchant 130. FIG. 12 illustrates an exemplary user interface for completing a transaction of purchasing products from the online merchant 130. The merchant can tap “It's Done” button 1205 to complete the transaction or “Not Yet” button 1210 if there is a pending activity like sending a survey, the need to capture additional information, the associate accidently taps “Mark as Paid” etc. to complete the transaction.

### Computing Machine Architecture

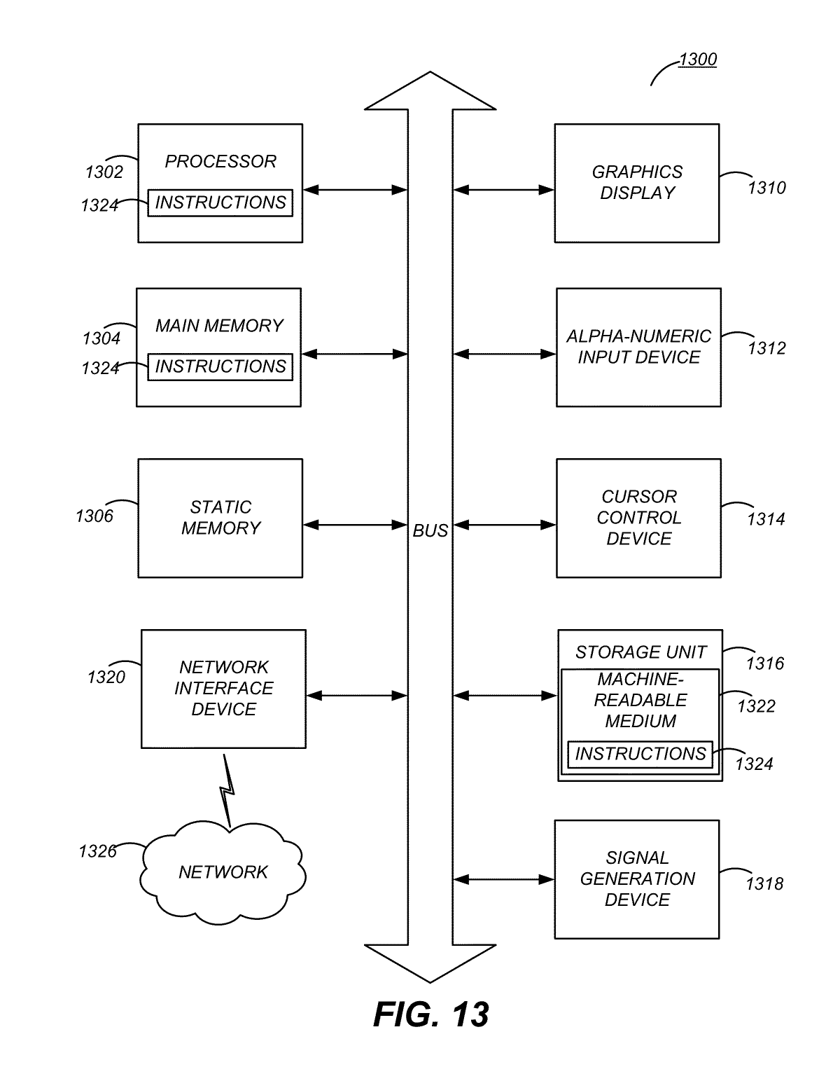

FIG. 13 is a block diagram illustrating components of an example machine able to read instructions from a machine-readable medium and execute them in a processor (or controller). Specifically, FIG. 13 shows a diagrammatic representation of a machine in the example form of a computer system 1300 within which instructions 1324 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. Note that the consumer device 105 and merchant device 160 can be structured as the computer system 1300 and can operate the respective portions of the process described through FIG. 4 and FIGS. 5 through 12.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1324 (sequential or otherwise) that specify actions to be taken by that machine. Further, while only a single machine is illustrated, the term “machine” shall also be taken to include any collection of machines that individually or jointly execute instructions 1324 to perform any one or more of the methodologies discussed herein.

The example computer system 1300 includes a processor 1302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1304, and a static memory 1306, which are configured to communicate with each other via a bus 1308. The computer system 1300 may further include graphics display unit 1310 (e.g., a plasma display panel (PDP), a liquid crystal display (LCD), a projector, or a cathode ray tube (CRT)). The computer system 1300 may also include alphanumeric input device 1312 (e.g., a keyboard), a cursor control device 1314 (e.g., a mouse, a trackball, a joystick, a motion sensor, or other pointing instrument), a storage unit 1316, a signal generation device 1318 (e.g., a speaker), and a network interface device 1320, which also are configured to communicate via the bus 1308.

The storage unit 1316 includes a machine-readable medium 1322 on which is stored instructions 1324 (e.g., software) embodying any one or more of the methodologies or functions described herein. The instructions 1324 (e.g., software) may also reside, completely or at least partially, within the main memory 1304 or within the processor 1302 (e.g., within a processor's cache memory) during execution thereof by the computer system 1300, the main memory 1304 and the processor 1302 also constituting machine-readable media. The instructions 1324 (e.g., software) may be transmitted or received over a network 1326 via the network interface device 1320.

While machine-readable medium 1322 is shown in an example embodiment to be a single medium, the term “machine-readable medium” should be taken to include a single medium or multiple media (e.g., a centralized or distributed database, or associated caches and servers) able to store instructions (e.g., instructions 1324). The term “machine-readable medium” shall also be taken to include any medium that is capable of storing instructions (e.g., instructions 1324) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Example benefits and advantages of the disclosed configurations include secure process of conducting an electronic transaction involving credit card exchanges in an online marketplace. A technological benefit of setting up payments by this process is that the credit card information does not reside on any third party application servers, thereby reducing risks from electronic security issues such as electronic data breaches. This means that the information is not susceptible to hacking or potential misuse of credit card information, leading to a secure exchange of credit card information. To add to the security aspect, the credit card information is displayed for a limited time to the merchant, and the merchant cannot take a screen shot of the credit card, or charge the credit card multiple times. All of the mentioned fraudulent activities can be detected by the merchant application 145. Moreover, the encrypted credit card information may be converted to a machine readable code such as QR code, which cannot be read by a merchant, when entering into a terminal. The terminal can read the QR code and charge the credit card for payment purposes.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1, 2, 3 and 4. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 102, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for providing an electronic method of credit card information exchange that represents a physical handover of the credit card and return of the credit card at a marketplace through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer implemented process for conducting a transaction, the process comprising:
receiving a request from a consumer device to view goods from one or more online merchants, each online merchant associated with a merchant device;
responding to the request from the consumer device by transmitting a list of available goods at the online merchant;
receiving a request from the consumer device to purchase goods from one of the online merchant;
receiving a request, from a merchant device associated with the online merchant from which the purchased goods were requested by the consumer device, to obtain credit card information through the consumer device;
receiving credit card information from the consumer device and encrypting the credit card information using a public key encryption; and
transmitting the encrypted credit card information to the merchant device over a network, the encrypted credit card information decryptable by a private key on the merchant device.

2. The process of claim 1, further comprising:
receiving a request via a communication module on the consumer device; and
broadcasting the request to the communication modules of the merchant devices.

3. The process of claim 1, wherein the public key information is stored on the server.

4. The process of claim 1, wherein the encrypted credit card information is secured by converting to a machine readable code.

5. The process of claim 1, wherein the credit card information is decrypted using a private key stored on a merchant device.

6. The process of claim 5, wherein the private key is stored on the merchant device.

7. The process of claim 1, wherein a view of the credit card information is enabled on the merchant device for a predefined interval of time to allow completion of a transaction of purchasing goods.

8. The process of claim 7, wherein enabling the view of credit card information enables the start of a timer on the merchant device.

9. The process of claim 7, wherein enabling the view of the credit card information enables detecting a screen shot capture on the merchant device for the predefined interval of time corresponding to the credit card information view time.

10. The process of claim 1, wherein the credit card information on the merchant device is destroyed on at least one of expiration of the predefined interval of time or an indication of completion of the transaction of purchasing goods.

11. The process of claim 10, wherein indication of completion of the transaction of purchasing goods includes providing an input via a user interface of an application on a merchant device.

12. A computer readable medium configured to store instructions, the instructions when executed by a processor cause the processor to:
receive a request from a consumer device to view goods from one or more online merchants, each online merchant associated with a merchant device;
respond to the request from the consumer device by transmitting a list of available goods at the online merchant;
receive a request from the consumer device to purchase goods from one of the online merchant;
receive a request, from a merchant device associated with the online merchant from which the purchased goods were requested by the consumer device, to obtain credit card information through the consumer device;
receive credit card information from the consumer device and encrypting the credit card information using a public key encryption; and
transmit the encrypted credit card information to the merchant device over a network, the encrypted credit card information decryptable by a private key on the merchant device.

13. The computer readable medium of claim 12, further comprising instructions that cause the processor to:
receive a request via a communication module on the consumer device; and
broadcast the request to the communication modules of the merchant devices.

14. The computer readable medium of claim 12, further comprising instructions that cause the processor to secure the encrypted credit card information by converting it to a machine readable code.

15. The computer readable medium of claim 12, further comprising instructions that cause the processor to decrypt the credit card information on a merchant device using a private key that is stored on the merchant device.

16. The computer readable medium of claim 12, further comprising instructions that cause the processor to enable a view of the credit card information on the merchant device for a predefined interval of time to complete a transaction of purchasing goods.

17. The computer readable medium of claim 12, further comprising instructions that cause the processor to enable the start of a timer along with the view of credit card information on the merchant device.

18. The computer readable medium of claim 12, further comprising instructions that cause the processor to enable the detection of a screen shot capture along with enabling the view of the credit card information for the predefined interval of time corresponding to the credit card information view time on the merchant device.

19. The computer readable medium of claim 12, further comprising instructions that cause the processor to destroy the credit card information on the merchant device on at least one of expiration of the predefined interval of time or an indication of completion of the transaction of purchasing goods.

20. The computer readable medium of claim 19, further comprising instructions that cause the processor to detect an input via a user interface of an application on a merchant device indicating a completion of the transaction of purchasing goods.

21. A system for conducting a transaction, the system comprising:
a consumer device configured to send requests to the merchant device to view or purchase goods, receive requests from a merchant device to obtain credit card information, encrypt the credit card information using a public key and transmit the encrypted credit card information using a public key and transmit the encrypted credit card information over the network; and
a merchant device configured to receive requests from a consumer device to view goods, respond to the requests by generating and transmitting a product list, receive requests from a consumer device to purchase goods, respond with a request to obtain credit card information, receive encrypted credit card information that is decryptable by the merchant device using a private key.

22. The system of claim 21 further comprising:
receiving a request via a communication module on the consumer device; and
broadcasting the request to the communication modules of the merchant devices.

23. The system of claim 21, wherein the consumer device is further configured to secure the encrypted credit card information by converting to a machine readable code.

24. The system of claim 21, wherein the merchant device is further configured to store a private key.

25. The system of claim 21, wherein the merchant device is further configured to enable a view of the credit card information for a predefined interval of time to complete a transaction of purchasing goods.

27. The system of claim 21 wherein the merchant device is further configured to enables the start of a timer on enabling the view of credit card information.

28. The system of claim 21 wherein the merchant device is further configured to enable detecting a screen shot capture for the predefined interval of time corresponding to the credit card information view time.

29. The system of claim 21 wherein the merchant device is further configured to remove the credit card information upon the expiration of the predefined interval of time or an indication of completion of the transaction of purchasing goods.

30. The system of claim 21, wherein the merchant device is configured to receive an indication of completion of the transaction of purchasing goods that includes providing an input via a user interface of an application on the merchant device.
